(19) United States
(12) Patent Application Publication
(10) Pub. No.: US 2004/0143795 A1
(43) Pub. Date: Jul. 22, 2004

(54) Display data creating technique for automatically Providing efficient representation of portal pages with improved visual recognition

(76) Inventor: Takaya Matsuishi, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/691,691

(22) Filed: Oct. 24, 2003

(30) Foreign Application Priority Data
Oct. 25, 2002 (JP) 2002-311708
Oct. 16, 2003 (JP) 2003-356393

(51) Int. Cl. G06F 17/21

(52) U.S. Cl. 715/530

(57) ABSTRACT

A display data creating apparatus is disclosed that creates display data representing multiple display sections. Each of the display sections contains a prescribed type of information, created in response to a request from a client terminal supplied via a network. The apparatus transmits the display data to the client apparatus via the network. The apparatus comprises a determination part that determines for at least one of the display sections whether the information to be contained in a current display section satisfies a prescribed condition. A display data creating part updates the current display section in accordance with the determination result to create the display data.

### BACKGROUND OF THE INVENTION

1. Field of the Invention

The present invention relates to a technique for creating display data that are to be supplied through a network to a client apparatus and are capable of providing efficient representation of a portal page with improved visual recognition.

2. Description of Related Art

Along with the development of Web technology in recent years and continuing, users of the Internet can easily access and read variety of information at numerous sites provided throughout the world, using general-purpose browsers. However, in these days, information available on Web sites has become enormous, and it is difficult for the users to search for the desired information. To overcome this inconvenience, Internet portal sites are widely spreading, and a portal to the Internet has now become indispensable for Internet users.

On the other hand, many companies started introducing EIP (Enterprise Information Portal) as means for sharing information on the intranet to allow employees to efficiently obtain necessary information.

Regardless of the type of the portal site, such as an Internet portal site or EIP, the web page (portal page) provided by such a portal site is generally divided into multiple areas, in each of which highly usable information elements are displayed. In other words, the user can look at multiple types of valuable information on a single display screen. This convenient availability is one of the factors that has allowed portal sites to become popular.

However, as the size of Web pages increase due to the increased amount of information that is to be displayed in the browser display window, a new problem arises. That is, it becomes difficult for the user to recognize where the necessary information is located in the Web page. Depending on the type of information, some information does not necessarily have to be displayed all the time on the portal page. For example, information about equipment (e.g., printers) connected over the network does not have to be always displayed in the web page. It is sufficient for such equipment information to be displayed only when malfunction occurs or when a requested job has been completed.

JPA 2000-3258 and JPA 6-83551 disclose techniques for reporting printer information or completion of a job executed by a network printer to a terminal apparatus connected to the printer via a network.

Meanwhile, to visually clean up the portal page, it is proposed to provide a minimization button or delete button on the portal page so as to allow the user to minimize or delete a frame (display section) that contains insignificant information or currently unnecessary information. It is also proposed to exclude infrequently required information from the portal page and to display it in popup dialogue boxes only when it is required.

However, minimization of a frame (display section) and indication in a popup dialogue box have other problems. Once the user minimizes the frame containing information about malfunction of equipment, the user cannot recognize occurrence of malfunction until the minimized area is maximized next time.

When using a popup dialogue box, malfunction or other information of the network equipment is indicated in the popup dialog box. During the indication in the popup dialogue box, the user cannot operate on the browser. This is because the popup dialogue box represented by the browser employs a modal interface that prohibits other tasks until the current task is completed. Consequently, the user is forced to close the popup dialogue box. Once the popup dialogue box is closed, it cannot be reopened, and the user cannot confirm the information about the network equipment any longer.

The minimization of the display section and the popup dialogue box may be combined. In this case, the occurrence of malfunction is indicated in the popup dialogue box, while the detailed information about the malfunction is posted in one of the display sections on the portal page. If the user normally keeps this display section minimized, then, the user has to maximize this area to check the malfunction information after the popup dialogue box is closed. This process imposes extra steps of manipulation on the user.

### SUMMARY OF THE INVENTION

The present invention was conceived in view of the above-described background, and it is an object of the present invention to provide a technique for creating display data that can improve visual recognition of necessary information, while reducing user's manipulation workload.

To achieve the object, in one aspect of the invention, a display data creating apparatus creates display data representing a plurality of display sections, each of the display sections containing a prescribed type of information, in response to a request from a client apparatus supplied via a network, and transmits the display data to the client apparatus via the network. This apparatus comprises a determination part that determines for at least one of the display sections whether the information to be contained in a current display section satisfies a prescribed condition, and a display data creating part that updates the current display section in accordance with the determination result to create the display data.

With the display data creating apparatus, if the prescribed condition is satisfied in a certain display section, display data are created so that this display section is emphasized or expanded with update information contained in it, by updating the display section.

When the created display data are transmitted to and displayed on the client apparatus, the user can immediately visually recognize which display section is currently updated.

Since the display data do not require a new window or a popup dialogue box to be opened, the user's manipulation workload can be reduced.

### BRIEF DESCRIPTION OF THE DRAWINGS

Other objects, features, and advantages of the present invention will become more apparent from the following detailed description when read in conjunction with the accompanying drawings, in which:

FIG. 1 is an example of the system structure to which the display data creating technique of the present invention is applied according to an embodiment of the invention;

FIG. 2 is an example of the hardware structure of the Web server according to an embodiment of the invention;

FIG. 3 is an example of the software configuration of the Web server according to an embodiment of the invention;

FIG. 4 is an example of the functional structure of the Web server according to the embodiment of the invention;

FIG. 5 is an example of a part of the screen configuration data file implemented by XML;

FIG. 6 is an example of another part of the screen configuration data file implemented by XML;

FIG. 7 is an example of the display format of the portal page created according to the screen configuration data;

FIG. 8A and FIG. 8B are examples of display modes;

FIG. 9 is a sequence diagram showing the procedure of displaying a portal page;

FIG. 10 is an example of a portal page displayed on the screen;

FIG. 11 is an example of a portal page, in which the calendar unit is minimized;

FIG. 12 is an example of a portal page, in which the right area is pulled toward the bottom with the calendar unit minimized;

FIG. 13 is a flowchart showing the operation of creating a portal page;

FIG. 14 is a flowchart showing the operation carried out for the conditioned unit;

FIG. 15 is an example of a portal page, in which the printer information unit and the document list unit are minimized;

FIG. 16 is a flowchart showing the operation carried out for an ordinary unit;

FIG. 17 is a flowchart showing the operation of creating a portal page, while dynamically varying the layout of the respective units;

FIG. 18 is a flowchart showing the operation carried out for the conditioned unit, while dynamically varying the layout of the unit;

FIG. 19 is an example of a screen configuration working data file, in which the unit definition of the document list unit has been moved to the top;

FIG. 20 is an example of a portal page, in which the document list unit is arranged at the top right because the contents of the document list have been updated;

FIG. 21 is an example of a Web system, in which an image processing apparatus is used as the Web server;

FIG. 22 is an example of a Web system, in which an image processing apparatus is used as the SOAP server;

FIG. 23 is an example of a Web system, in which multiple image processing apparatuses are connected over the network, each functioning as a Web server or a SOAP server; and

FIG. 24 is an example of a Web system, in which an image processing apparatus furnished with both the Web server function and the SOAP server function is connected over the network.

### DETAILED DESCRIPTION OF THE INVENTION

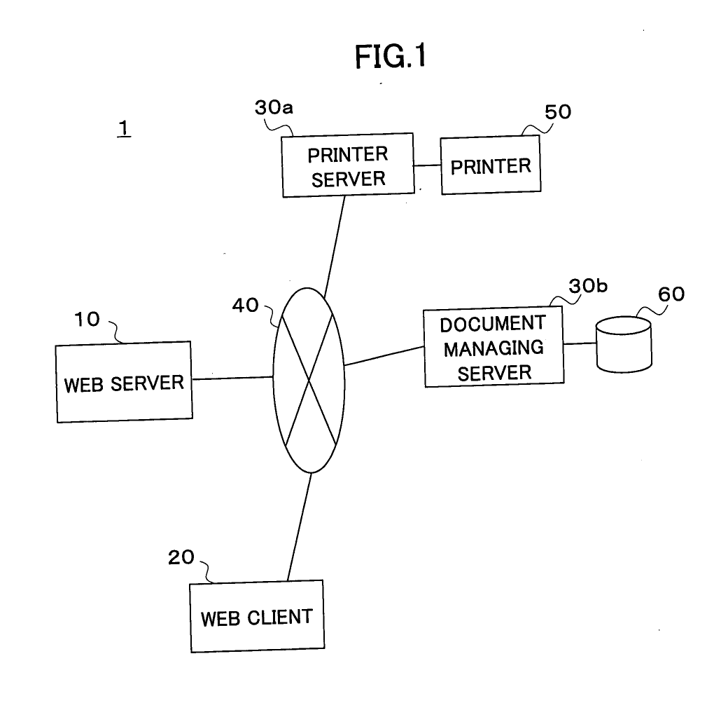

The preferred embodiments of the present invention are next described with reference to the attached drawings. FIG. 1 illustrates the network structure of the Web system according to an embodiment of the invention. Web system 1 includes a Web server 10, a Web client 20, a printer server 30a and a document managing server 30b, which are mutually connected via the network 40.

Web client 20 is a terminal apparatus in which a Web browser is installed, and it may be a PC (personal computer), a PDA (personal digital assistants), a cellular phone, or any other suitable device. Although in the drawing only a single Web client 20 is depicted, multiple Web clients may be connected over the network 40.

In this embodiment, a Web page is used as an example of display data represented on the display screen of the Web client 20. A web page is generally created in HTML (HyperText Markup Language) or XML (Extensible Markup Language) data format; however, any suitable data format may be used, other than HTML and XML, as long as a general-purpose browser can refer to it.

Printer server 30a is a computer that offers a print service as a Web service over the network 40, which is carried out by the printer 50 connected to the printer server 30a. A function of the printer server 30a can be called by SOAP-RPC (remote procedure control). For example, printer server 30a offers a “printer information acquiring method” for acquiring information about the status of the printer 50 over the network 40.

Document managing server 30b is a computer that offers a document management service for document data stored in document database (DB) 60 as a Web service over the network 40. The functions of the document managing server 30b can be called by SOAP-RPC. For instance, the document managing server 30b offers a “document list acquiring method” for acquiring the list of the document data stored in an arbitrary folder in the document database 60.

In the following, a server whose functions can be called by SOAP-RPC is referred to as a “SOAP server”. In the example shown in FIG. 1, printer server 30a and document managing server 30b are called “SOAP servers”.

The Web server 10 is a computer that functions as a display data creating apparatus that creates and transmits a Web page (i.e., a data file displayed in the browser) to the Web client 20. In response to a request for a Web page from the Web client 20, the Web server 10 calls the functions of the printer server 30a or any other SOAP servers (not shown) through SOAP-RPC, and collects necessary information required to create the Web page. The created Web page information is transmitted to the Web client 20. This means that the Web server 10 does not have to possess any contents in advance because it collects necessary information to create a Web page via the network 40. Of course, the Web server 10 may have installed a function for executing some services.

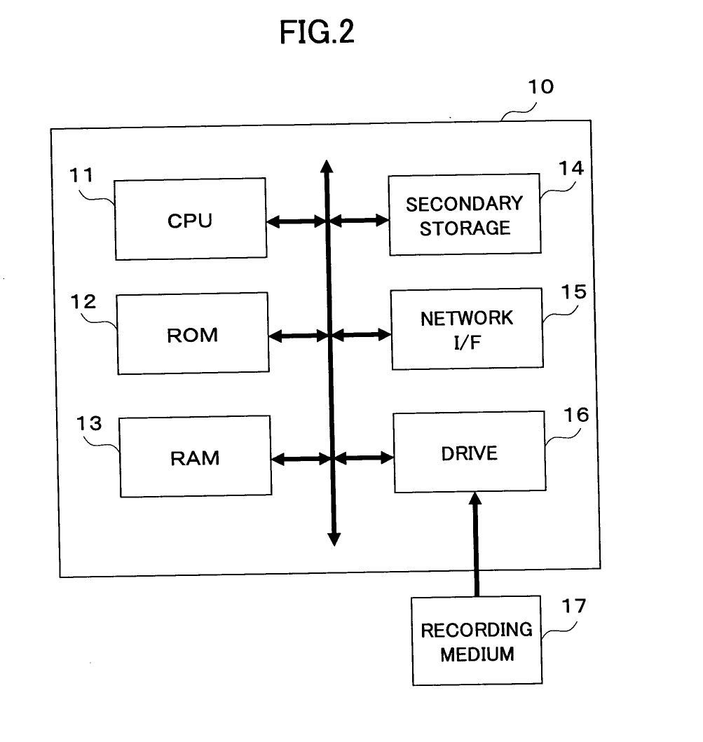

FIG. 2 is a block diagram showing the hardware structure of the Web server 10 according to an embodiment of the invention. Web server 10 has CPU 11, ROM 12, RAM 13, secondary storage 14, network interface (I/F) 15, and drive 16.

CPU 11 controls the entire operation of the Web server 10, and executes various types of control programs and application programs stored in ROM 12 and the secondary storage 14 to control the data flow and communications through the network in order to acquire and edit data.

ROM 12 stores control programs of devices mainly, and RAM 13 is used as a working memory and a temporary memory area of the CPU 11.

Secondary storage 14, which stores various types of application programs and data and can store files as necessary, will be described below. Network interface (I/F) 15 is an interface to connect the Web server 10 to the network 40. Drive 16 reads recording medium 17, such as a CD-ROM, in which the program for executing the functions of the present invention is stored.

Although not shown in FIG. 2, the Web server 10 may also be furnished with a manipulation unit with a keyboard or a mouse, and/or a display unit, such as a LCD or CRT, to allow the user to input information and to display the operation result.

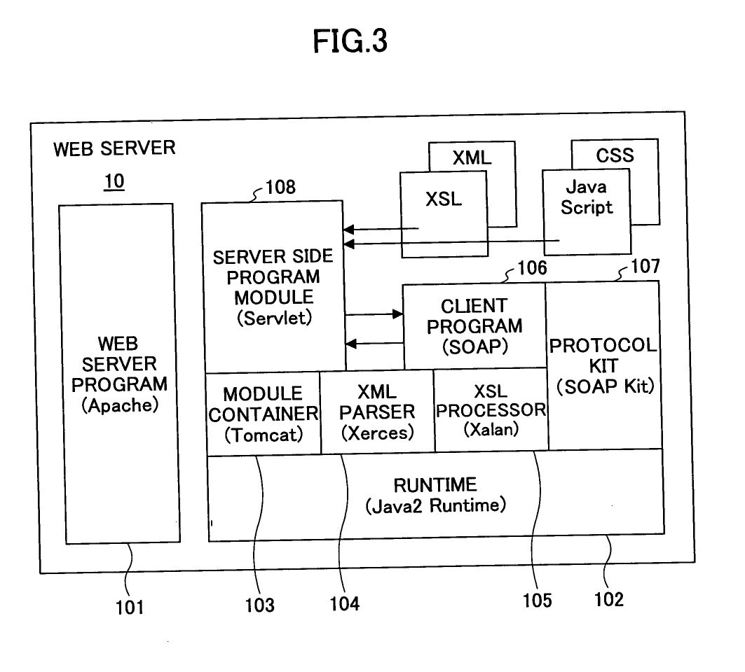

FIG. 3 illustrates the software configuration of the Web server 10 according to an embodiment of the invention.

The Web server 10 comprises Web server program 101, Runtime 102, module container 103, XML parser 104, XSL processor 105, client program 106, protocol kit 107, and server-side program module 108. The CPU 11 reads the necessary program from the secondary storage 14 or ROM 12 and executes it to carry out a required process. Alternatively, such software may be obtained externally via the network I/F 15.

The Web server program 101 is adapted to transmit a Web page data or other information to the Web client 20 in response to a request from the Web client 20 in the Web system 1. For example, Apache offered by Apache Software Foundation may be used as the Web server program 101.

Runtime 102 is a software module required to execute application software. In this example, Java (registered trademark) 2 Runtime is used to execute application software created by the program language of Java 2 provided by Sun Microsystems, Inc.

Module container 103 provides the execution environment in which to execute the server-side program module 108, and it may employ, for example, Tomcat offered by Apache Software Foundation.

XML parser 104 parses XML documents and spreads XML data described in a text format in the memory in a data tree structure so as to facilitate data handling by other applications. For example, Xerces offered by Apache Software Foundation may be employed.

XSL (Extensible Stylesheet Language) processor 105 is used to convert XML data in accordance with XSL data, and it may be realized by, for example, Xalan offered by Apache Software Foundation.

Client program 106 is used to request the SOAP server, such as the printer server 30a, to carry out a process, and software capable of communicating under SOAP is employed. Protocol kit 107 is software for actually carrying out communications in accordance with the request.

Server-side program module 108 is a modularized program executed on the Web server 11. In this example, JAVA (registered trademark) 2 Servlet is employed. Many processes proposed by the present invention are realized by this server-side program module 108 which causes the CPU 11 to carry out various functions. For instance, in response to a request from the Web client 20, the server-side program module 108 causes the CPU 11 to call the function of the printer server 30a or to create a Web message.

When converting XML data into HTML data with reference to XSL data in the Web server 11, Cascading Stylesheet (CSS) data, which define a display format that cannot be covered by either HTML or XSL specification, or Java (registered trademark) Script code, which defines an error popup operation, may also be used together with the XSL data. Necessary CCS data or JavaScript codes can be described directly in the XSL data, or alternatively, reference to the CSS data or JavaScript codes may be buried in the XSL data that is conversion data.

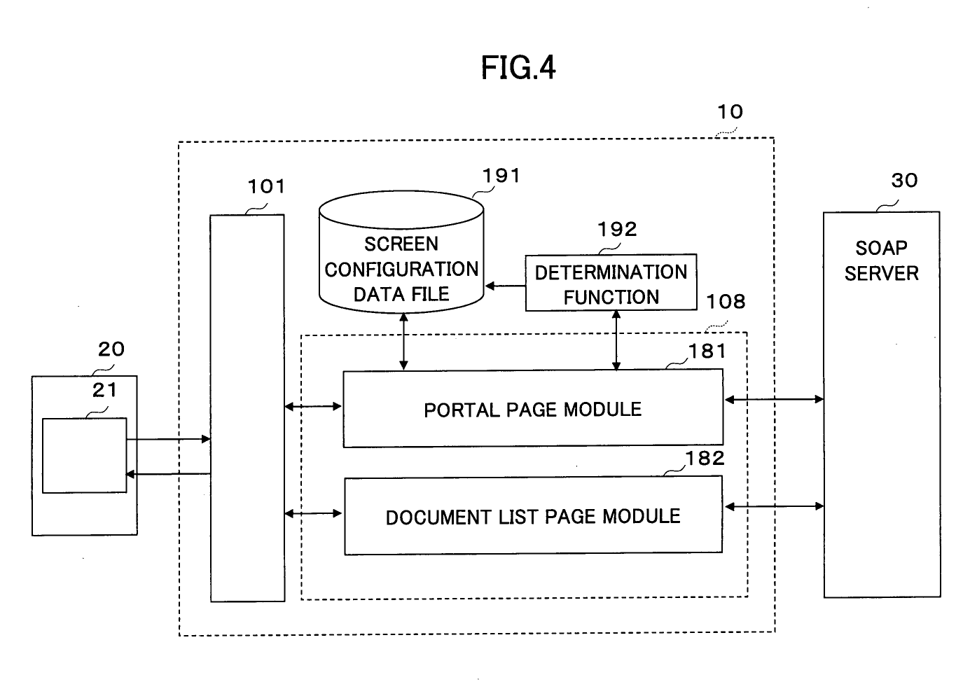

FIG. 4 illustrates the functional structure of the Web server 10 according to an embodiment of the invention. The Web server 10 includes a portal page module 181 and a document list page module 182, a screen configuration data file 191, and a set of determination functions 192.

Portal page module 181 is implemented as a component of server side program module 108, and is started by the Web server program 101 in response to a request for a portal page transmitted from the Web browser 21 of the Web client 20. To send the portal page data to the Web client 20, the portal page module 181 collects necessary information from the SOAP server 30, such as the printer server 30a or the document managing server 30b to create a portal page that contains the collected information and other HTML data. In this context, a portal page is a page or a file in which various types of information are integrated on a single Web page. The user of the Web client 20 accesses the portal page as the portal to the Internet or the intranet, using the Web browser 21.

The document list page module 182 is implemented as a component of server side program module 108, and is started by the Web server program 101 in response to a request for a document list page transmitted from the Web browser 21 of the Web client 20. To supply the document list to the Web client 20, the document list page module 182 acquires information about the list of the document data from the document managing server 30b to create a Web page (referred to as a “document list page”) that indicates a list of document data.

Although not shown in FIG. 4, many other modules are furnished, other than the portal page module 181 and the document list page module 182, to handle requests transmitted from the Web client 20 for various pages. The modules, including the portal page module 181 and the document list page modules 182, are collectively referred to as a “page module”.

The determination functions set 192 is used to determine whether each type of information received by the portal page module 181 from the corresponding SOAP server 30 satisfies a prescribed condition. A necessary function is called by the portal page module 181, and a determination result is given to the portal page module 181. Depending on the determination result, the portal page module 181 changes and adjusts the layout of the frames (which layout is referred to as a “display format”) of the portal page, each frame containing associated information.

The screen configuration data file 191 manages information about the definition of each page indicating which frame (or display section) of a given portal page contains what kind of information. To be more precise, the screen configuration data file 191 manages, for example, a frame layout item indicating how the portal page is divided into rectangular sections (which are named frames or unit display sections), an information acquiring function item indicating how to acquire information to be displayed in the associated frame (display section), and a determination function item indicating a prescribed reference function used to determine the display format of the portal page. These items that constitute the screen configuration data file 191 are collectively referred to as “screen configuration information”. The portal page module 181 creates a portal page according to the definition of the screen configuration data file 191. The screen configuration data file 191 is controlled for each of the users, who utilize the Web system 1 through the Web clients 20. Accordingly, the Web server 10 creates a portal page personalized for each user, which is transmitted to and displayed on the Web client 20 of the corresponding user. Since the portal page is created according to the screen configuration information, the frame layout or the design of the portal page can be adjusted easily simply by changing the screen configuration data file 191.

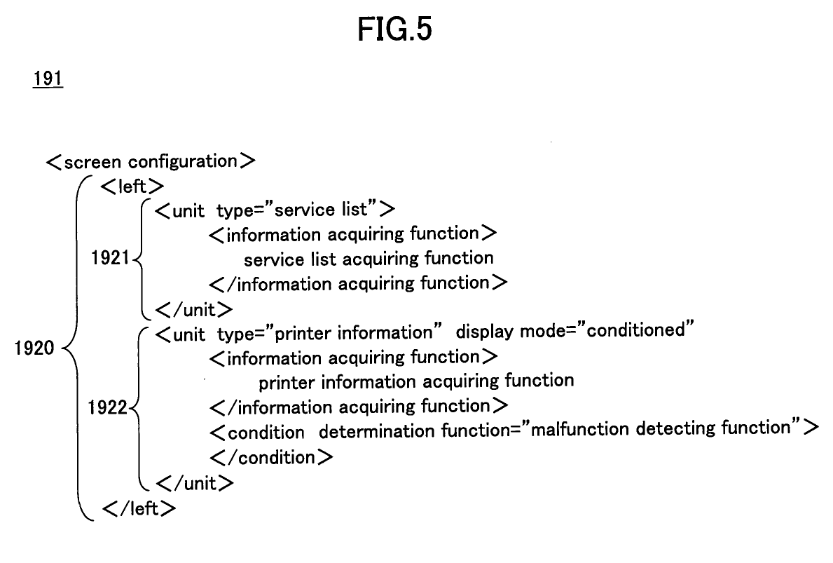

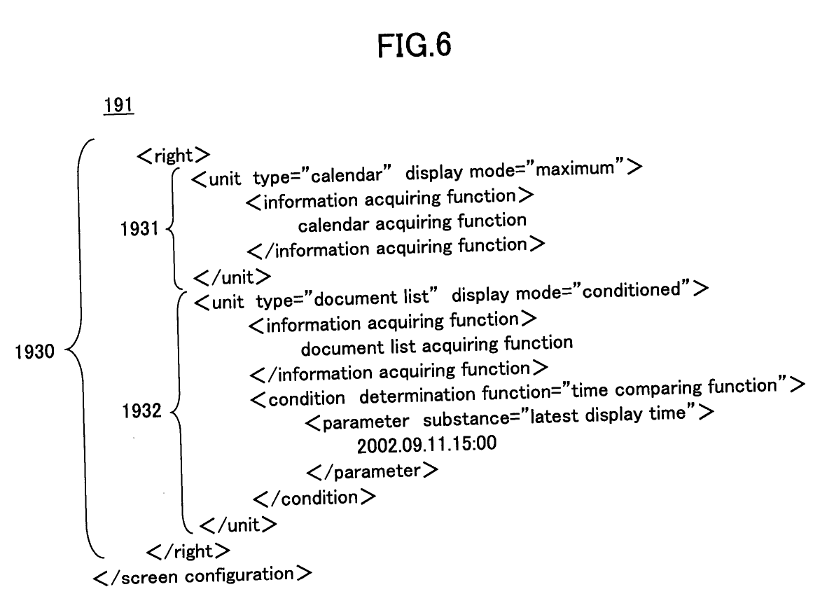

The screen configuration data file 191 is explained in more detail below with reference to FIG. 5 through FIG. 7. FIG. 5 and FIG. 6 illustrate portions of a single screen configuration data file 191. The halves shown in FIG. 5 and FIG. 6 make up the screen configuration data file of a single portal page.

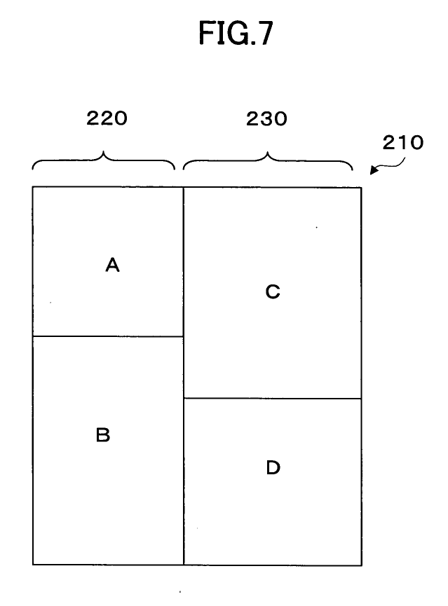

Throughout FIG. 5 and FIG. 6, the “screen configuration” tags (that is, <screen configuration> of FIG. 5 and </screen configuration> of FIG. 6) define screen configuration information for a portal page 210 shown in FIG. 7.

The left definition 1920 marked off by the “left” tags shown in FIG. 5 and the right definition 1930 marked off by the “right” tags shown in FIG. 6 represent that the portal page 210 is divided into two areas (the left area 220 and the right area 230) in the horizontal direction. Although in this example the portal page is divided into two parts in the horizontal direction, the number of horizontally divided parts can be suitably selected. For example, to divide the portal page into three parts in the horizontal direction, a new definition is added at the same hierarchical level as the left definition 1920 and the right definition 1930.

The left definition 1920 and the right definition 1930 define the left area 220 and the right area 230, respectively, of the portal page 210. The left definition 1920 includes two unit definitions 1921 and 1922. The two unit definitions in the left definition 1920 indicate that the left area 920 is divided into two areas in the vertical direction. Each unit denotes one of the multiple frames (or display sections) arranged on the portal page 210. In other words, the unit definition 1921 defines frame A (referred to as “unit A”) of the portal page 210, and the unit definition 1922 defines frame B (referred to as “unit B”) shown in FIG. 7.

Similarly, the right definition 1930 includes two unit definitions 1931 and 1932, which indicate that the right area 230 is divided into two, namely, unit C and unit D, in the vertical direction. The number of areas arranged in the left area 220 and the right area 230 in the vertical direction can be adjusted arbitrarily by simply changing the number of unit definitions.

The unit tag of each unit definition contains the “type” attribute, and the value of the “type” attribute represents the type of information to be displayed in the corresponding frame or unit area. For example, the unit definition 1921 has a type attribute of “service list”, which indicates that the service list is to be displayed in the corresponding unit area. It should be noted that the character string of “service list” does not have any significant meaning as a value, and that it is used simply as a characteristic string for indication.

In addition, unit definitions 1922, 1931 and 1932 have “display mode” attributes in their unit tags. The display mode attribute defines the display format of the associated unit (or the frame). In this embodiment, the display mode attribute has four values, “maximum”, “minimum”, “delete”, and “conditioned”.

Although not shown in FIG. 7, each unit has a title bar. The unit whose display mode is set to “maximum” indicates that the size of the display area of that unit is enlarged so as to allow the information contained in that unit to be viewed (maximization). In contrast, the unit whose display mode is set to “minimum” indicated that the display area of this unit is closed, and only the title bar is left on the portal page (minimization).

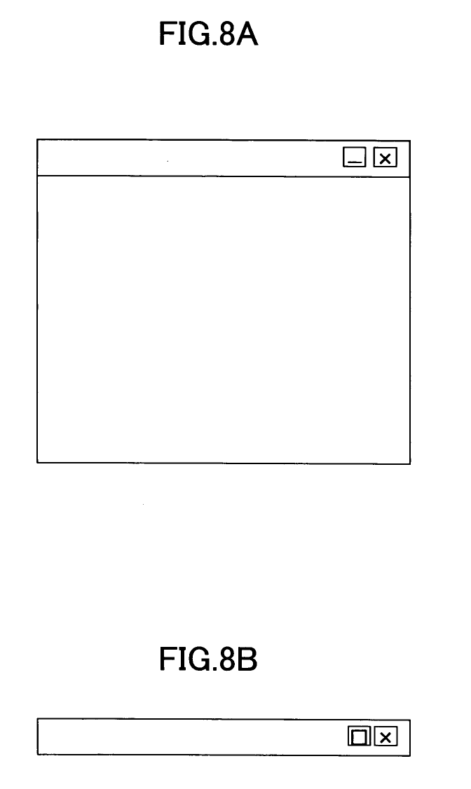

FIG. 8A and FIG. 8B are examples of the display formats. FIG. 8A is an example of maximization of a unit, and FIG. 8B is an example of minimization of the unit.

If the display mode of a unit definition is set to “delete”, the corresponding unit is excluded from the display window of the portal page, and the entire display section including the title bar is removed from the portal page. Concerning the unit whose display mode is set to “conditioned” in the unit definition, when a prescribed condition is satisfied for the unit, the unit is maximized. When the condition is not satisfied, then the unit is minimized in the portal page.

In FIG. 5, the unit definition 1921 does not have the display mode attribute. This means that the corresponding unit area is always displayed at the maximum size in the portal page.

As shown in FIG. 5 and FIG. 6, each unit definition includes a definition of an information acquiring function, which is marked off by the “information acquiring function” tag. The information acquiring function defines interface information for acquiring information that is to be contained in the unit (or the frame) of the portal page. For instance, the information acquiring function of the unit definition 1921 describes interface information such as the function name (i.e., the service list acquiring function) or an argument. The contents displayed in unit A are information acquired by calling the service list acquiring function.

Similarly, the unit definitions 1922, 1931, and 1932 include a printer information acquiring function, a calendar information acquiring function, and a document list acquiring function, respectively. These functions are called to acquire necessary information to be displayed in the associated units. For example, by calling the printer information acquiring function, the printer information acquiring method of the printer server 30a is called by the SOAP-RPC. When the document list acquiring function is called based on the definition, the document list acquiring method of the document managing server 30b is called.

Although in this example information is acquired by calling the associated function, the URL or the file name of the file storing necessary information may be described in place of the information acquiring function in the definition.

The unit definition defining a unit area with the conditioned display mode includes a definition of the condition, which is marked off by the “condition” tag. The condition definition describes interface information used as a reference to determine whether the display format of the unit is set to maximum or minimum. The “determination function” attribute of the condition tag has a value designating the function name, which corresponds to the determination function 192 used to determine the display format. The parameter definition under the condition definition designates a parameter value that is to be supplied as an argument to the determination function 192. If the determination function 192 does not have an argument, no parameter definition is placed under the condition definition.

For example, the unit definition 1922 has the determination function 192 designating a malfunction detecting function, and this function does not have an argument. On the other hand, the unit definition 1932 describes the determination function 192 designating a time comparing function, and this function has a parameter designating the latest display time.

Although in this example the determination function is called to determine whether the prescribed condition is satisfied, a determination formula may be described in place of the interface information of the determination function.

In the above-described example, the screen configuration data file 191 is implemented by XML, but it may be implemented by means of a CSV file or a table.

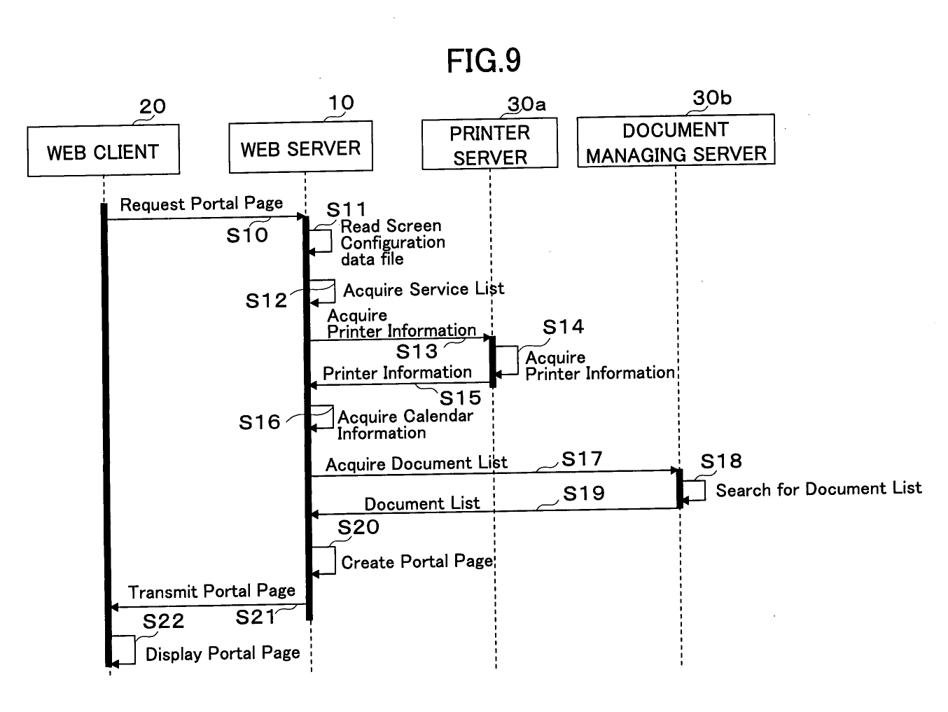

Next, description is made of a procedures performed in the Web system 1 shown in FIG. 1. FIG. 9 is a sequence diagram showing the outline of the process carried out when displaying a portal page requested by a Web client. FIG. 9 shows the major process flow, and details of the respective determination steps are omitted. The sequence of FIG. 9 shows only one of the process flows branching off at each determination step and diverging in several patterns.

First, in step S10, the Web client 20 transmits a request for a portal page 210 to the Web server 10 in response to manipulation through the Web browser 21 by the user. The Web client 20 also transmits identification information together with the request so that the Web server 10 identifies the user of the Web client 20. Examples of the identification information include a user ID and a password. A password is set in advance in the portal page 210, and the user inputs the password through the Web browser 21 when transmitting a request for the portal page 210. Alternatively, the user ID may be registered in the cookie of the Web client 20 through a user registration procedure, and the cookie may be transmitted from the Web browser 21 when transmitting the request for the portal page.

In step S11, the portal page module 181 of Web server 10 identifies the user of the Web client 20 based on the identification information supplied together with the transmission request for the portal page 210, and reads the screen configuration data file 191 defined for that user. In this example, the screen configuration data file 191 illustrated in FIG. 5 and FIG. 6 is read.

In step S12, the portal page module 181 calls the service list acquiring function in accordance with the definition of the information acquiring function defined in unit definition 1921 shown in FIG. 5 to acquire information to be displayed in unit A of the portal page 210 shown in FIG. 7.

In step S13, the portal page module 181 calls a printer information acquisition function in accordance with the definition of the information acquiring function defined in unit definition 1922 shown in FIG. 5, in order to call the printer information acquiring method of the printer server 30a. Upon the call of the printer information acquiring method, the printer server 30a acquires information about printer 50 (in step S14), and transmits the acquired information to the Web server 10 (in step S15). The information about printer 50, which is transmitted from the printer server 30a, is to be contained in unit B shown in FIG. 7.

Then, in step S16, the portal page module 181 calls the calendar information acquiring function in accordance with the definition of the information acquiring function defined in unit definition 1931 of FIG. 6, and it acquires information to be contained in unit C of FIG. 7.

In step S17, the portal page module 181 calls for the document list acquiring function in accordance with the definition of information acquiring function defined in unit definition 1932 shown in FIG. 6, thereby calling the document list acquiring method of the document managing server 30b. Upon the call of the document list acquiring method, the document managing server 30b retrieves from the document database 60 the document list (in step S18), and transmits the retrieved information to the Web server 10 (in step S19). The document list supplied from the document managing server 30b is to be contained in unit D shown in FIG. 7.

In step S20, the portal page module 181 arranges the information collected by steps S12 through S19 according to the layout defined by the screen configuration data file 191 to create HTML data (that is, the portal page 210), and transmits the created portal page data to the Web client 20 (in step S21).

In step S22, the Web browser of the Web client 20 displays the portal page 210.

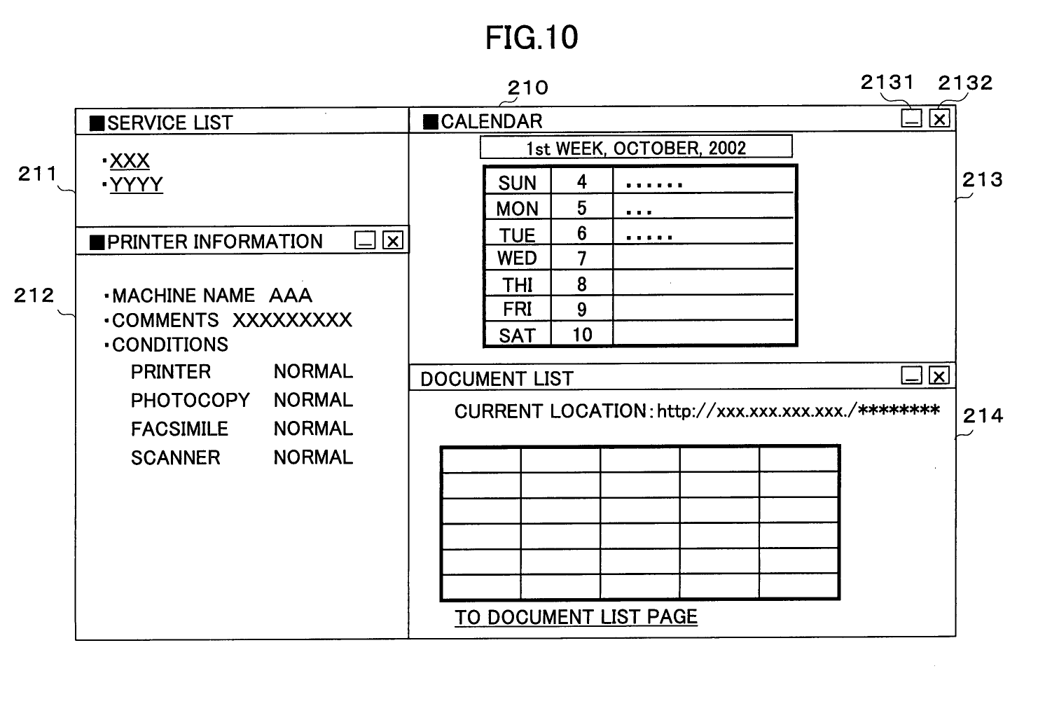

FIG. 10 is an example of the display screen of the portal page 210. The portal page 210 shown in FIG. 10 comprises four frames, namely, a service list unit 211, a printer information unit 212, a calendar unit 213, and a document list unit 214.

The service list unit 211 contains a list of services (destinations of links) provided by this portal page 210. The printer information unit 212 contains information about printer 50 acquired from the printer server 30a. The calendar unit 213 contains calendar information. The document list unit 214 contains a list of document data of an arbitrary folder in the document database 60, which is acquired from the document management server 30b.

In manipulation of portal page 210, using the minimization button and the delete button furnished in the title bar, a frame is manipulated. For example, the title bar of the calendar unit 213 has the minimization button 2131 and the delete button 2132. When the minimization button 2131 is clicked, the calendar unit 2131 is minimized, and when clicking the delete button 2132, the entirety of the calendar unit 213 is removed from the portal page 210.

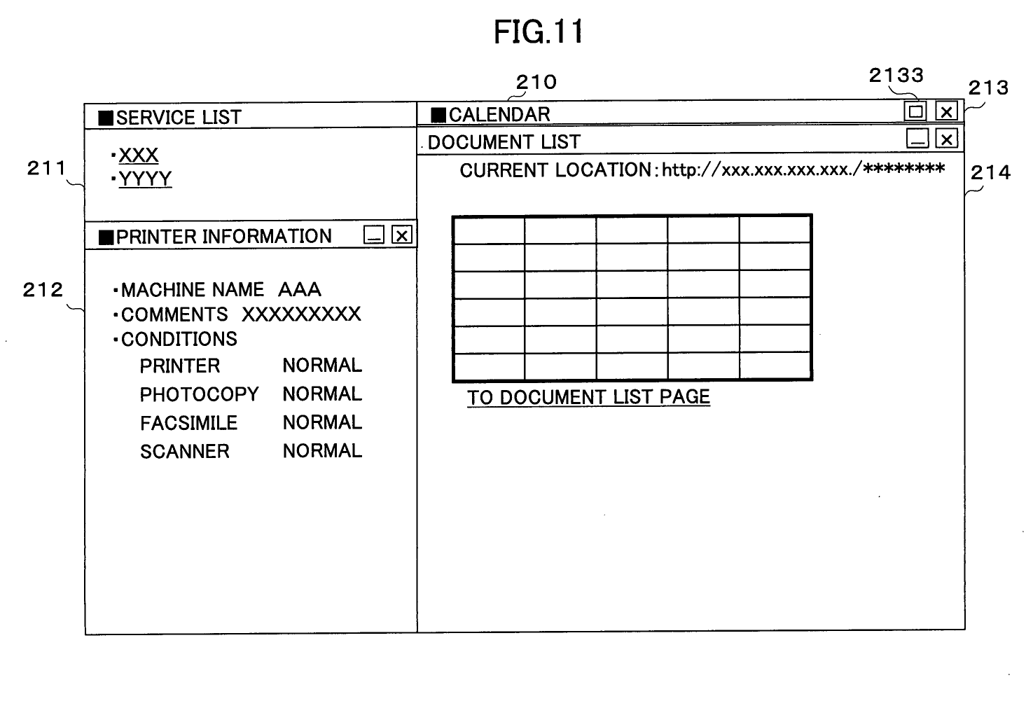

FIG. 11 is an example of the portal page 210, in which the calendar unit 213 is minimized, and only the title bar is displayed in the portal page 210. The title bar in the minimized state has a maximization button 2133, instead of the minimization button 2131. When the maximization button 2133 is clicked, the calendar unit 213 is maximized, and it returns to the maximized state shown in FIG. 10. Similarly, each of the title bars of the printer information unit 212 and the document list unit 214 has a minimization button and a delete button. When these units are minimized, the maximization buttons are displayed in the title bars. The minimization button, the delete button, and the maximization button are collectively referred to as a “display format switching button”.

The service list unit 211 does not have a display format switching button. This is because the unit definition 1921 of the screen configuration data file 191, which defines the screen layout of the service list unit 211, does not includes the display mode in its unit tag attribute. The portal page module 181 adds display format switching buttons to those units defined by the definitions designating the display mode, and does not add the display format switching button to those units without designation of display mode in their definitions, when creating the portal page 210.

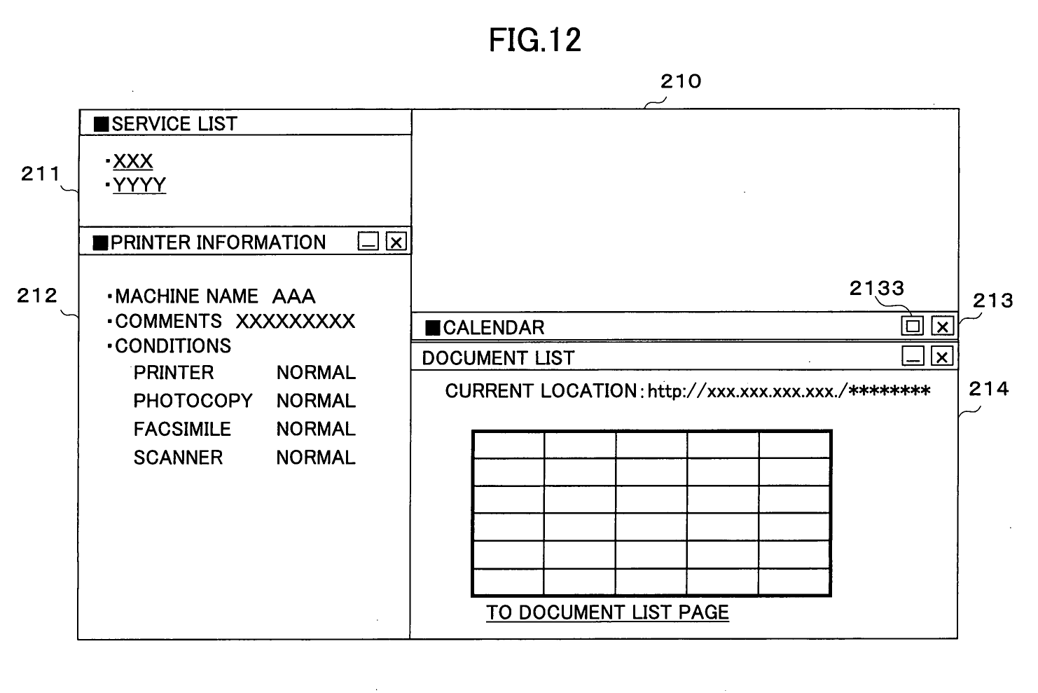

In FIG. 11, the calendar unit 213 is minimized toward the top right of the portal page 210. However, the location of the minimized unit is not limited to this example. For example, the calendar unit 213 may be minimized toward the bottom of its display area. FIG. 12 is an example of the portal page 210 in which the calendar unit is minimized toward the bottom of its display area.

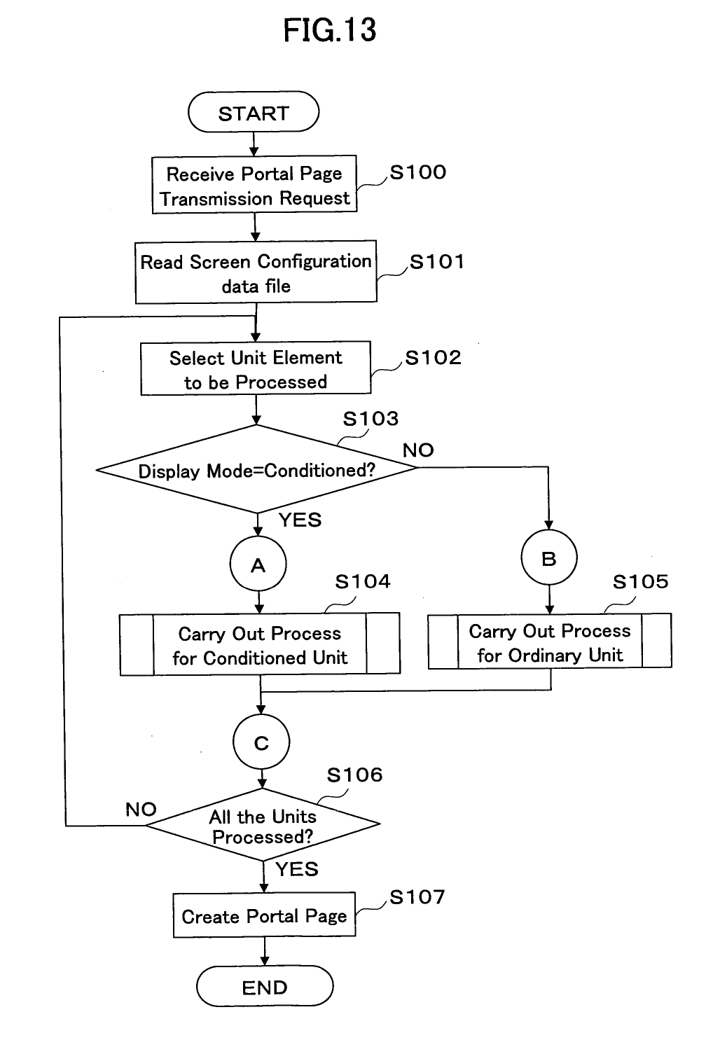

Based on the foregoing, the process carried out by the Web server 10 in steps S10 through S20 in FIG. 9 is explained next in more detail. FIG. 13 is a flowchart showing the operation of creating a portal page.

In step S100, when Web server program 101 of the Web server 10 receives a request for a portal page 210 from the Web client 20, it starts the portal page module 181. The request for the portal page 210 is transmitted from the Web client 20 not only when the user has requested on the Web browser 21 of the Web client to open the portal page 210, but also when the user clicks the display format switching button of an arbitrary unit in the already displayed portal page 210, or updates the representation of one of the multiple units arranged in the portal page 210. When the display format switching button is clicked, the identification information indicating which display format switching button has been clicked is transmitted as option information, together with the request for the portal page 210, to the Web server 10.

In step S101, the portal page module 181 reads the screen configuration data file 191.

In step S102, the portal page module 181 selects a unit definition (for example, unit definition 1921) as a target unit for processing from those defined in the screen configuration data file 191 shown in FIG. 5 and FIG. 6. The unit definition being processed is referred to as a “current unit definition”, and the unit arranged in the portal page 210 corresponding to the current unit definition is called a “current unit”.

In step S103, the portal page module 181 determines whether the display mode designated in the current unit definition is “conditioned”. If the display mode of the current unit definition is “conditioned” (that is, if the current unit definition is one denoted by 1922 or 1932 in FIG. 5 and FIG. 6, respectively), then, the process proceeds to step S104. If not, the process proceeds to step S105.

In step S104, the portal page module 181 carries out the process for a unit with the conditioned display mode (which is referred to as a “conditioned unit”) designating, for example, maximization or minimization of the display area. The process includes acquiring information to be displayed in the conditioned unit, and determination of the display format of the conditioned unit. Then, the process proceeds to step S106.

On the other hand, in step S105, the portal page module 181 carries out the process for a unit with an unconditioned display mode (which is referred to as an “ordinary unit”). The process includes acquiring information to be displayed in the ordinary unit, and determination of the display format. The processes carried out in steps S104 and S105 are described below in more detail.

In step S106, the portal page module 181 determines whether all the unit definitions defined in the screen configuration data file 191 have been processed. If there is any unit definition left without having been processed, the process returns to step S102, and repeats the steps S102 through 106 until all the unit definition are processed.

If all the unit definitions have been processed, the portal page module 181 creates a requested portal page 210 in step S107. The step S107 corresponds to step S20 shown in FIG. 9, and therefore, the portal page 210 created in step S107 is transmitted to the Web client 20.

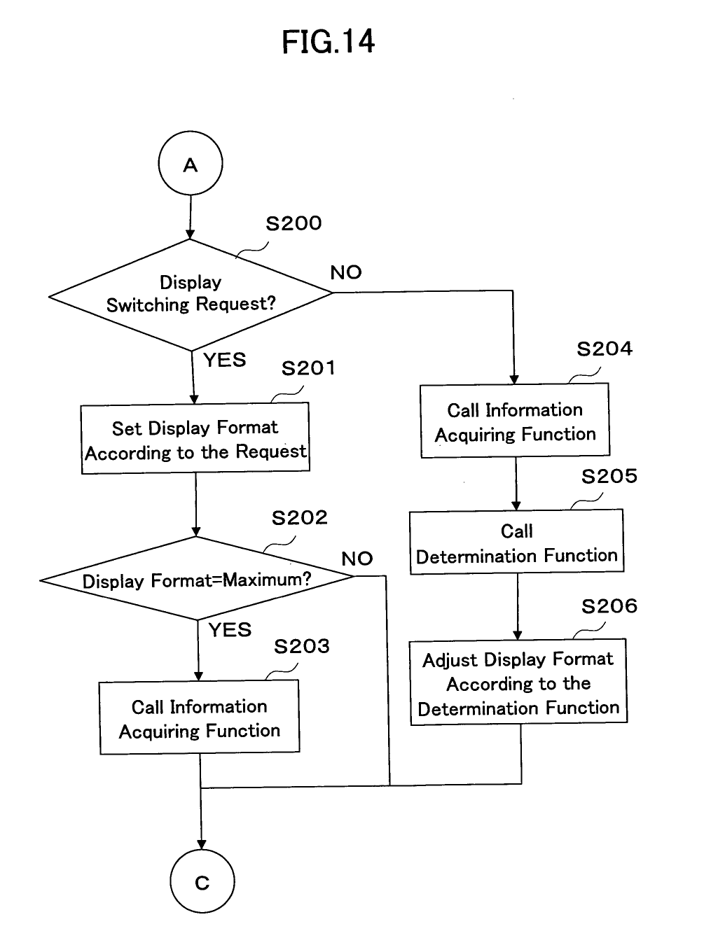

FIG. 14 is a flowchart showing the detailed process of step S104 shown in FIG. 13, which is carried out for the conditioned unit.

In step S200, the portal page module 181 determines whether the identification information of the display format switching button is designated as option information in the request for portal page 210 supplied from the Web client 20. In other words, it is determined whether the display format switching button of an arbitrary unit has been clicked (i.e., switching of the display format has been requested) in the portal page 210 which is already opened on the Web client 20. If the identification information of the display format switching button is designated as option information (YES in S200), the process proceeds to step S201.

In step S201, the portal page module 181 sets the display format of the current unit to that designated in the request as the option information corresponding to the manipulation of the display format switching button. For example, if the identification information of the display format switching button indicates manipulation of the minimization button, the frame or the display section of the current unit is minimized. If the identification information indicates manipulation of the maximization button, then the frame of the current unit is maximized.

In step S202, the portal page module 181 determines whether the display format set for the current unit is maximization.

If the currently set display format is maximization (YES in S202), the process proceeds to step S203, the portal page module 181 calls the information acquiring function defined for the current unit to obtain necessary information, which is to be displayed in the maximized display section of the current unit.

If the selected display format is not maximization (NO in S202), it is not necessary to display information in the current unit because the display format of the current unit is minimization or deletion in this example. Accordingly, no information acquiring function is called for.

If in step S200 identification information of the display format switching button is not designated as option information in the request for the portal page (NO in S200), the process proceeds to step S204. In this case, a request for opening a portal page 210 is newly made in the Web client 20.

In step S204, the portal page module 181 calls for the information acquiring function of the current unit definition to obtain information to be displayed in the frame of the current unit. If the current unit definition is unit definition 1922 shown in FIG. 5, information about the printer 50 is obtained by XML data from printer server 30a by calling the printer information acquisition function. If the current unit definition is unit definition 1932 shown in FIG. 6, then information representing a list of document data is acquired by XML data from the document managing server 30b by calling the document list acquiring function.

In step S205, following step S204, the portal page module 181 calls the determination function of the current unit definition, using the XML data received in step S204 as input information, to determine the display format of the current unit.

For example, if the current unit definition is unit definition 1922, the portal page module 181 calls the malfunction detecting function as the determination function 192. (See FIG. 5.) The malfunction detecting function is used to analyze the contents of information about the printer 50, which is previously transmitted as XML data from the printer server 30a, in order to determine whether malfunction has occurred in printer 50. When it is determined that malfunction has occurred in printer 50, the malfunction detecting function returns a value of “TRUE”. When it is determined that no malfunction has occurred, then a value of “FALSE” is returned.

If the current unit definition is unit definition 1832, the portal page module 181 calls a time comparing function as the determination function. In this case, latest display time designated as a parameter is given as input information, in addition to the XML data.

The time comparing function is used to compare the updated time contained in the prescribed folder of the document database 60, which is previously transmitted as XML data from the document managing server 30b, with the latest display time designated as the input information when the time comparing function is called for. If the updated time is later than the latest display time, a value of “TRUE” is returned. In all the other cases, a value of “FALSE” is returned. In addition, when the updated time is later than the latest display time, the time comparing function updates the value of the latest display time described in the parameter definition. By updating the parameter value of the latest display time, the time comparing function can determine whether the information that is transmitted from the document managing server 30b next time is new as compared with the information having been displayed on the Web client 10 last time.

In step S206 following step S205, when the value returned from the determination function 192 is “TRUE”, the portal page module 181 maximizes the frame of the current unit. If the returned value if “FALSE”, then the current unit is minimized.

For example, if the current unit is printer information unit 212, and if malfunction has occurred in printer 50, then the printer information unit 212 is maximized. In all the other cases, the printer information unit 212 is maintained minimized. If the current unit is document list unit 214, and if the information in the folder of the document database 60 has been updated since the latest display time, then the document list unit 214 is maximized. In all the other cases, the document list unit 214 is maintained minimized.

In the operation flow shown in FIG. 14, when the display format switching button is clicked in the conditioned unit on the Web client 20, that is, if there is an expressed request for changing the display format, then the portal page module 181 changes the display format of the current unit in accordance with the request. If there is no expressed request as to the conditioned unit from the Web client 20, the portal page module 181 sets the display format of the current unit in accordance with the value returned from the determination function 192.

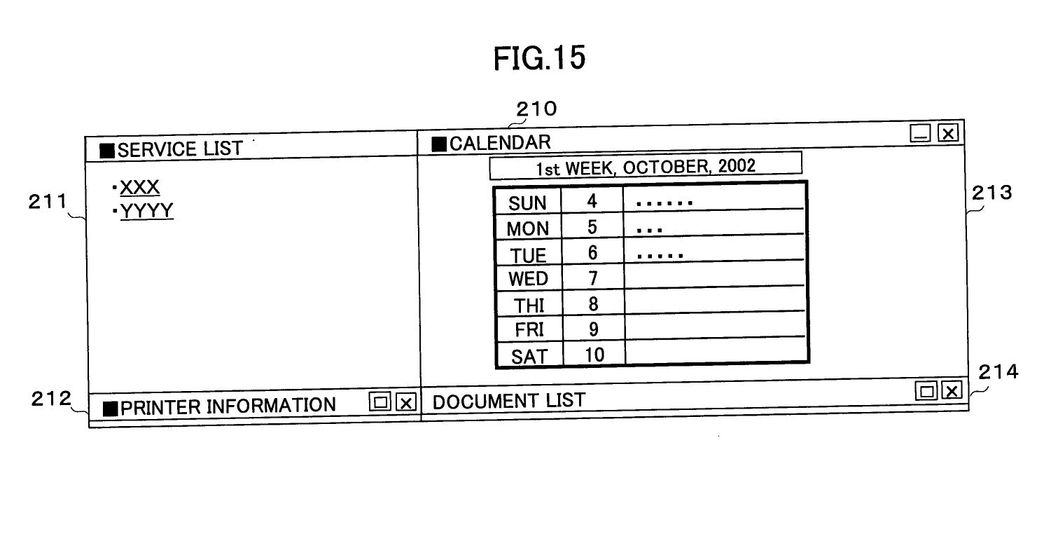

If the minimization buttons of the printer information unit 212 and the document list unit 214 are clicked in the portal page 210 shown in FIG. 10, the Web server 10 creates a portal page 210 with the printer information unit and the document list unit minimized, as shown in FIG. 15, and supplies this portal page 210 to the Web client 20.

If, in the portal page 210 shown in FIG. 15 in which both the printer information unit 212 and the document list unit 214 are minimized, then the Web server 10 creates a portal page 210 with the designated unit maximized, and supplies the portal page 210 to the Web client.

The user may cause the Web browser 21 to open another Web page, while leaving the printer information unit 212 and the document list unit 214 of the portal page 210 minimized as shown in FIG. 15, to work on the newly opened Web page. When the user finishes the task and causes the Web page to again display the portal page 210, the printer information unit is automatically maximized if malfunction has occurred in printer 50 since last time. Similarly, the document list unit 214 is automatically maximized when the portal page is reopened if the folder of the document database 60 has been updated since last time. In this manner, any unit whose display information has been updated since latest display time is maximized and emphasized to attract the user's attention to the updated unit.

With this arrangement, the user of the Web client 20 can recognize occurrence of printer malfunction or updating of the document database 60 by viewing the maximized (or emphasized) unit even if the conditioned unit, such as the printer information unit 212 or the document list unit 214, is minimized at the latest display time.

The Web server 10 informs the user of the occurrence of malfunction or updating of the database simply by maximizing the associated unit, without opening a new window with a modal interface, such as a popup dialogue box. Accordingly, the user does not have to conduct extra manipulations, for example, closing the newly opened dialogue box and checking the portal page.

The present invention is useful especially when the Web page is divided into multiple sections (i.e., units) as in portal page 210. Not so significant units are maintained minimized in the ordinary state, and are maximized only when required. On the other hand, those units containing information required for the current task are maximized. This arrangement improves the user's visual recognition of the portal page 210. The minimized frame is automatically maximized or emphasized when the prescribed condition is satisfied as to the information contained in the minimized unit. The user can easily recognize that some information is updated.

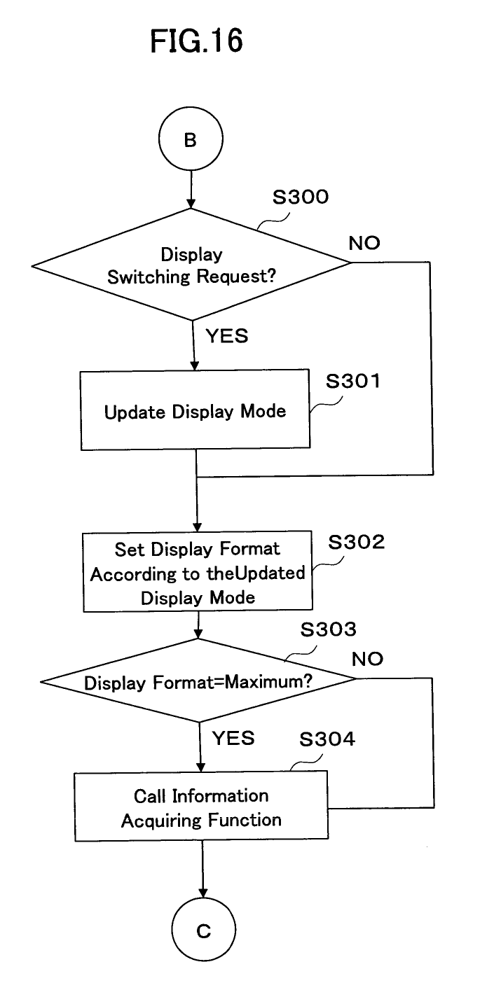

Next, the process for the ordinary (unconditioned) unit carried out in step S105 of FIG. 13 is explained with reference to the flowchart shown in FIG. 16.

In step S300, the portal page module 181 determines whether the identification information of the display format switching button is designated as option information in the request for portal page 210 supplied from the Web client 20. In other words, it is determined whether the display format switching button of an arbitrary unit has been clicked (i.e., switching of the display format has been requested) in the portal page 210 which is already opened on the Web client 20. If the identification information of the display format switching button is designated as option information (YES in S300), the process proceeds to step S301.

In step S301, the portal page module 181 updates the value of the display mode of the current unit definition described in the screen configuration data file 191 so as to agree with the function of the display format switching button whose identification information is designated as option information. For example, if the minimization button has been clicked, the value of the display mode is updated to “minimum”, and if the maximization button has been clicked, the value of the display mode is updated to “maximum”.

In step S302, the portal page module 181 sets the display format of the current unit in accordance with the display mode defined in the current unit definition.

In step S303, the portal page module 181 determines whether the display format set for the current unit is maximization. If the display format is maximization (YES in S303, the process proceeds to step S304, the portal page module 181 calls the information acquiring function defined for the current unit to obtain necessary information, which is to be displayed in the maximized display section of the current unit. If the selected display format is not maximum (NO in S303), it is not necessary to display information in the current unit, and accordingly, no information acquiring function is called.

In the operation flow shown in FIG. 16, when the display format switching button is clicked in the ordinary (or unconditioned) unit on the Web client 20, that is, if there is an expressed request for changing the display format, then the portal page module 181 sets the display format of the current unit in accordance with the request. If there is no expressed request from the Web client 20, the portal page module 181 sets the display format of the current unit in accordance with the display mode described in the screen configuration data file 191.

For example, when the minimization button of the calendar unit 213 is clicked in the portal page 210, the Web server 10 creates a portal page 210 in which the calendar unit 213 is minimized, and supplies this portal page to the Web client 20. When the maximization button is clicked on the title bar of the minimized calendar unit 213, then the Web server 10 creates a portal page 210 with the calendar unit 213 maximized, and again supplies the updated portal page 210 to the Web client 20.

In the above-described example, the location of each unit arranged in the portal page is fixed by the screen configuration data file 191. The service list unit 211 is arranged above the printer information unit 212, and the calendar unit 213 is arranged above the document list unit 214. However, to emphasize a specific unit, the location of the unit may be dynamically rearranged. For example, the unit containing updated information may be arranged at the top of the portal page to inform the user of the updating of the information. This arrangement also improves the user's visual recognition of the portal page 210.

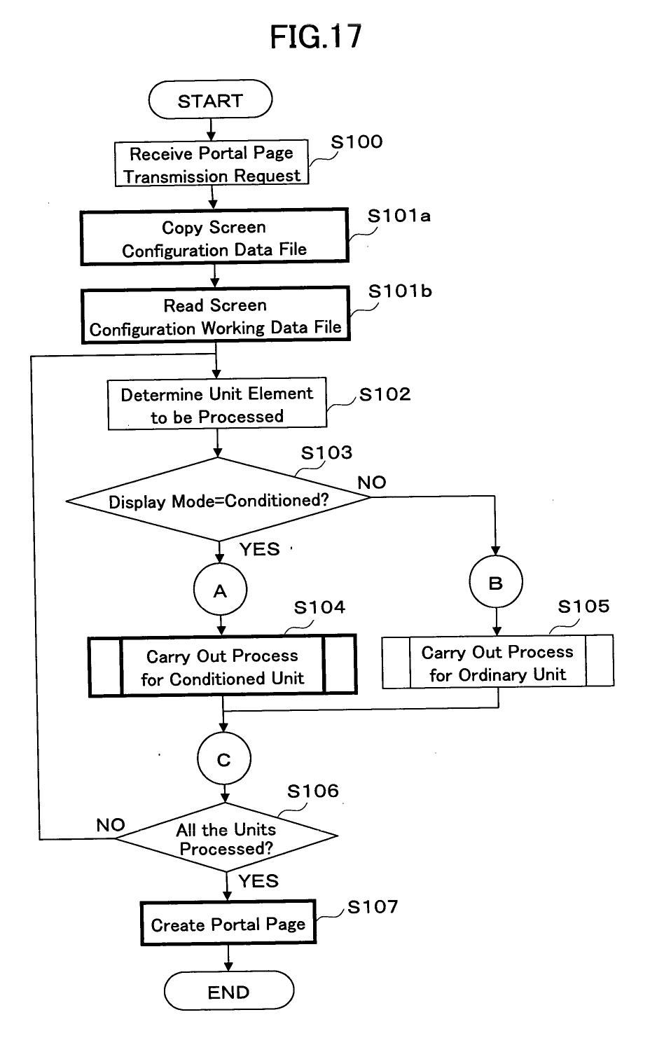

FIG. 17 is a flowchart showing the operation of creating a portal page by dynamically rearranging the locations of the units. In this flowchart, the steps similar to or corresponding to those steps shown in FIG. 13 are denoted by the same symbols. Only the modified portions from FIG. 13 are explained below.

Steps S101a and S101b correspond to step S101 of FIG. 13. In FIG. 17, a copy of the screen configuration data file 191 is created (S101a), and the copy (which is referred to as a “screen configuration working data file”) 191a is read (S101b). At this stage, the contents of the screen configuration data file 191 and the screen configuration working data file 191a are identical. Accordingly, the original data file 191 may be read in S101b.

Then, similar to the flow shown in FIG. 13, the display mode is determined for each unit, and when all the units have been processed, a portal page 210 is created. However, the process carried out in step S104 for the conditioned unit is modified.

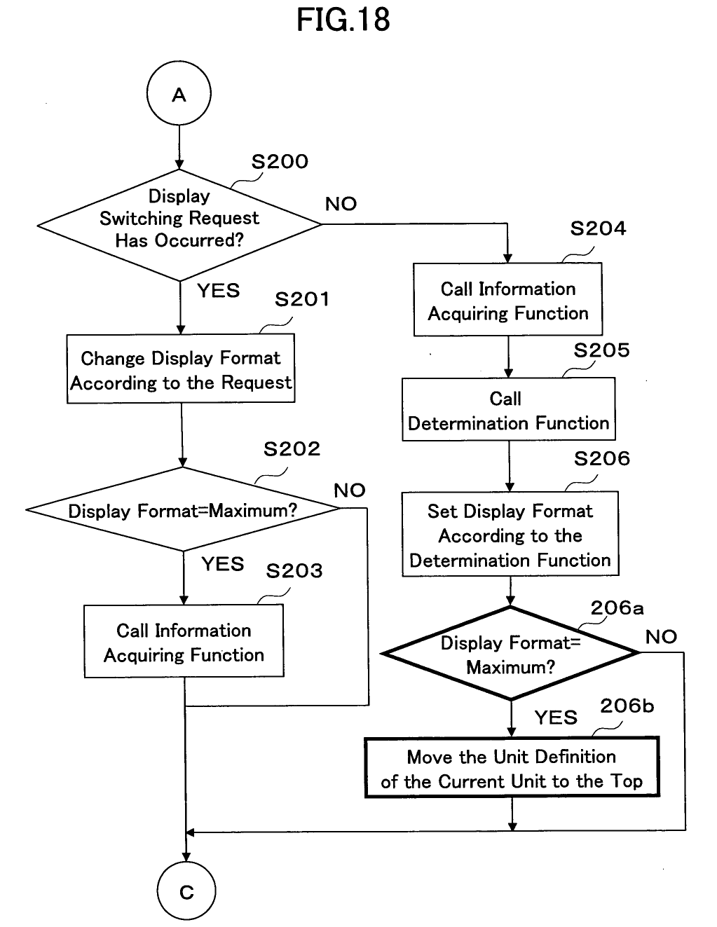

FIG. 18 is a flowchart showing the operation of dynamically changing the location of a conditioned unit in the portal page 210. In FIG. 18, the steps similar to those shown in FIG. 14 are denoted by the same symbols, and only the modified portions are explained below. In FIG. 18, steps S206a and S206b are inserted after step S206.

After the determination function is called (S205) and the display format is set in accordance with the determination function, the portal page module 181 determines in step S206a whether the display format of the current unit set by the determination function is “maximization”. If the display format is maximization (YES in S206a), the unit definition of the current unit is moved to the top of the left definition 1920 (FIG. 5) or the right definition 1930 (FIG. 6) in the screen configuration working data file 191a.

For example, if the current unit is document list unit 214, and if it is determined that the display format of the document list unit 214 is maximization, then, the unit definition 1932 for the document list unit 214 is moved to the top of the right definition 1930 to which the unit definition 1921 belongs.

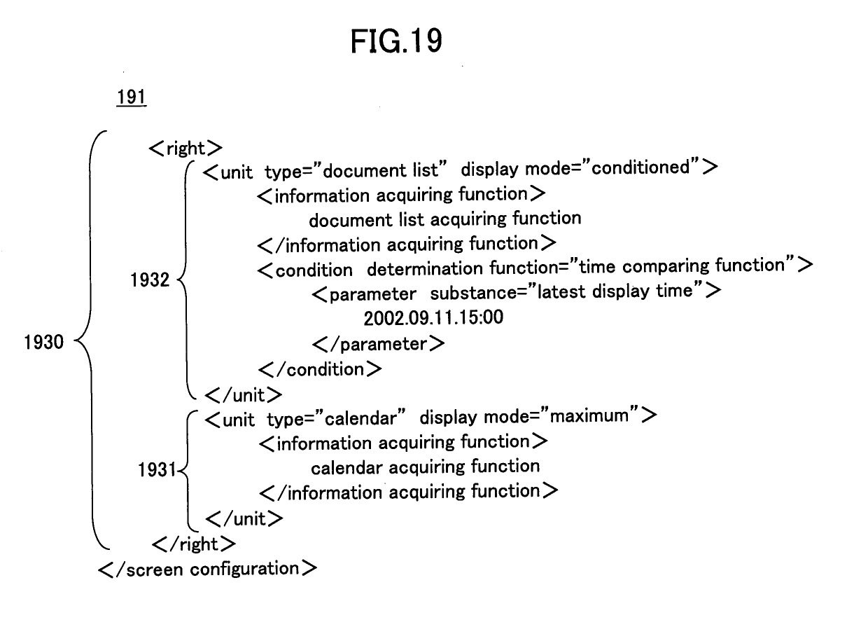

FIG. 19 is an example of the screen configuration working data file 191a in which the unit definition of the document list unit has been moved to the top. FIG. 19 shows only the right definition 1930 which includes the unit definition of the document list unit 214. The same sections as those shown in FIG. 6 are denoted by the same symbols, and explanation for them are omitted here.

Unlike the configuration shown in FIG. 6, the unit definition 1932 of the document list unit 214 is described in the top right definition 1930.

Returning to FIG. 17, the portal page module 181 creates a portal page 210 by determining the layout of the portal page 210 in accordance with the positions of the unit definitions described in the screen configuration working data file 191a.

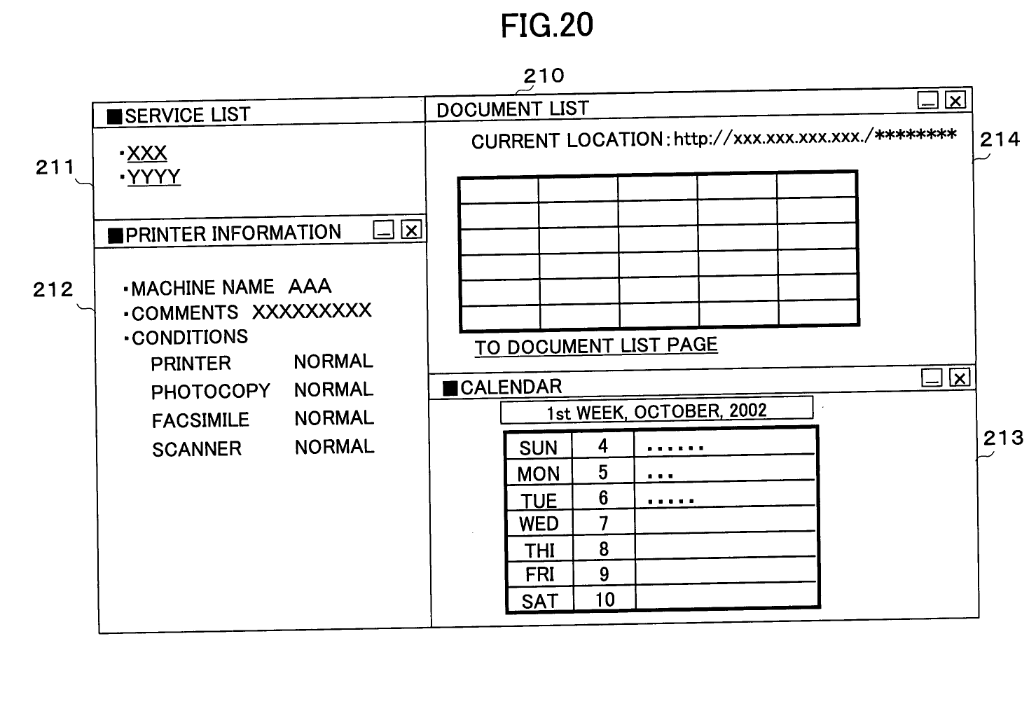

If the portal page 210 is created by the portal page module 191 based on the screen configuration working data file 191a illustrated in FIG. 19, the resultant portal page 210 becomes the one shown in FIG. 20.

As illustrated in FIG. 20, the document list unit 214 is arranged at the top right of the portal page 210. By arranging the unit containing updated information at the top, the user can visually recognize that the top unit contains some significant information. This arrangement is effective when several units are maximized in the portal page 210.

By editing the copy (i.e., the working data file) 191a of the screen configuration data file 191, instead of directly editing the screen configuration data file 191, the reference information can be maintained without being lost or deleted. Accordingly, if the information contained in the display list unit 214 is unchanged when the portal page 210 is requested next time, then the document list unit 214 is arranged under the calendar unit 213 as defined in the original screen configuration data file 191.

In this embodiment, if no malfunction has occurred in printer 50 or document database 60 has not been updated since the latest display, the corresponding units containing these information items are automatically minimized when the portal page is currently opened, even if the printer information unit 212 or the document list unit 214 is maximized at the latest display of the portal page 210. This arrangement can eliminate unnecessary manipulations by the user.

However, it is expected that automatic minimization of a maximized unit (frame) may be inappropriate or against the user's intention depending on the situation. In order to prevent automatic minimization, a new flag indicating whether the unit is currently maximized may be provided to the unit definition of the conditioned unit in the screen configuration data file 191.

In this case, if the flag is set to “maximization” when determining the display format of a conditioned unit, the portal page module 181 sets the display format of this conditioned unit to maximum, without waiting for the determination by the determination function. If the flag has a value of “minimization”, then the portal page module 181 determines the display format of the conditioned unit in according to the value returned from the determination function 192, as in the process shown in FIG. 14. This arrangement can prevent the unit previously maximized in the latest screen from being automatically minimized in the current screen.

By the way, a certain type of recently developed integrated apparatus specialized in a specific function is capable of functioning as a Web server, while executing information processing with a capability equal to a computer. An example of such an integrated apparatus is a multi-function image processing apparatus, which is also called a hybrid machine or a complex machine, and is furnished with multiple types of applications providing multiple services of printing, photocopying, facsimile, and other image formation and reproduction processes. Such a multi-function image processing apparatus can function as a Web server, and in addition, a certain type of multi-function image processing apparatus has a document managing function for storing photocopied information or facsimiled information as document data.

Therefore, the Web system 1 illustrated in the above-described embodiment may be comprised of a multi-function image processing apparatus. With such a multi-function image processing apparatus, the same effects and advantages can be achieved.

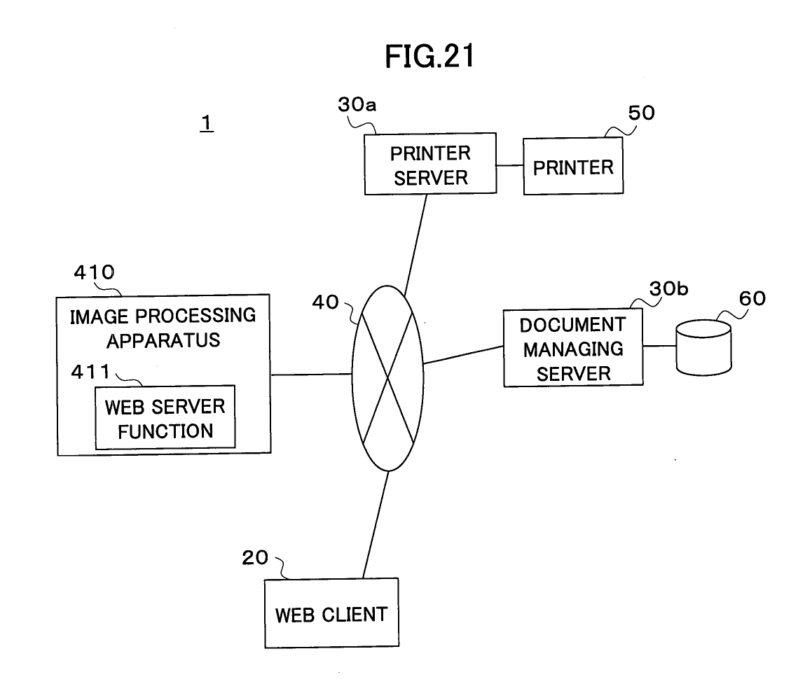

FIG. 21 shows a modification of the Web system 1, in which an image processing apparatus is used as the Web server. In FIG. 21, the same elements as those shown in FIG. 1 are denoted by the same numerical references, and explanation for them is omitted here. Comparing FIG. 21 with FIG. 1, image processing apparatus 410 is used in place of Web server 10 in the Web system 1.

The image processing apparatus 410 is installed with the Web server function 411 so as to able to carry out the same process as the Web server 10. In other words, Web server program 101 and various types of page modules are installed in the image processing apparatus 410.

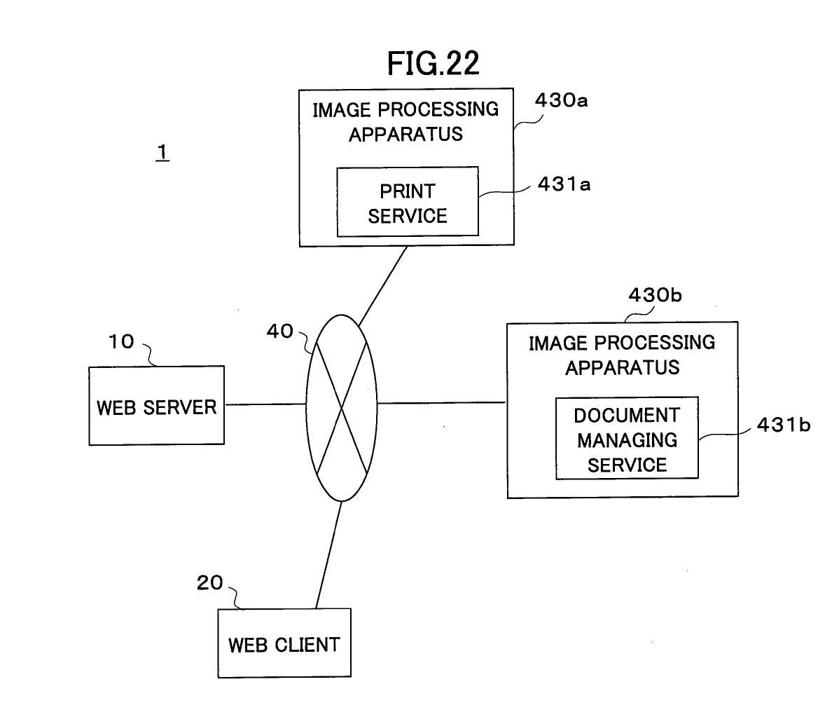

FIG. 22 shows another modification of the Web system 1, in which image processing apparatuses are used as the respective SOAP servers. In FIG. 22, the same elements as those shown in FIG. 1 are denoted by the same numerical references, and explanation for them is omitted. Comparing FIG. 22 with FIG. 1, image processing apparatuses 430a and 430b are used in place of the printer server 30a and the document managing server 30b, respectively.

The image processing apparatuses 430a and 430b are installed with print service 431a and document management service 431b, respectively, so as to serve as the printer server 30a and the document managing server 30b.

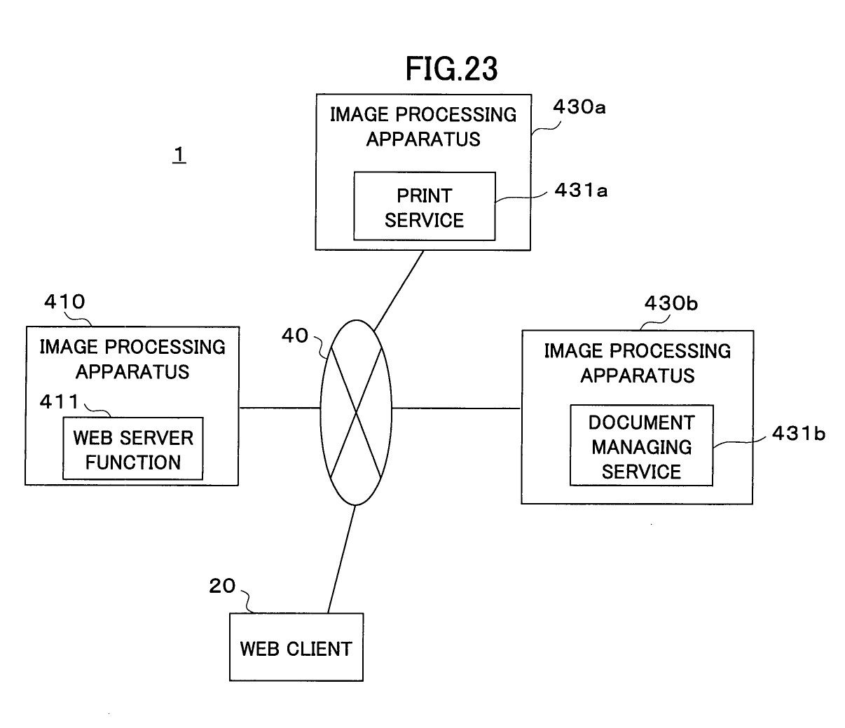

FIG. 23 shows still another modification of the Web system 1, in which image processing apparatuses are used as both the Web server and the SOAP server. In FIG. 23, the same elements as those shown in FIG. 1, FIG. 21, and FIG. 22 are denoted by the same numerical references, and explanation for them is omitted. The image processing apparatuses 410, 430a, and 430b function as the Web server 10, the printer server 30a, and the document managing server 30b, respectively.

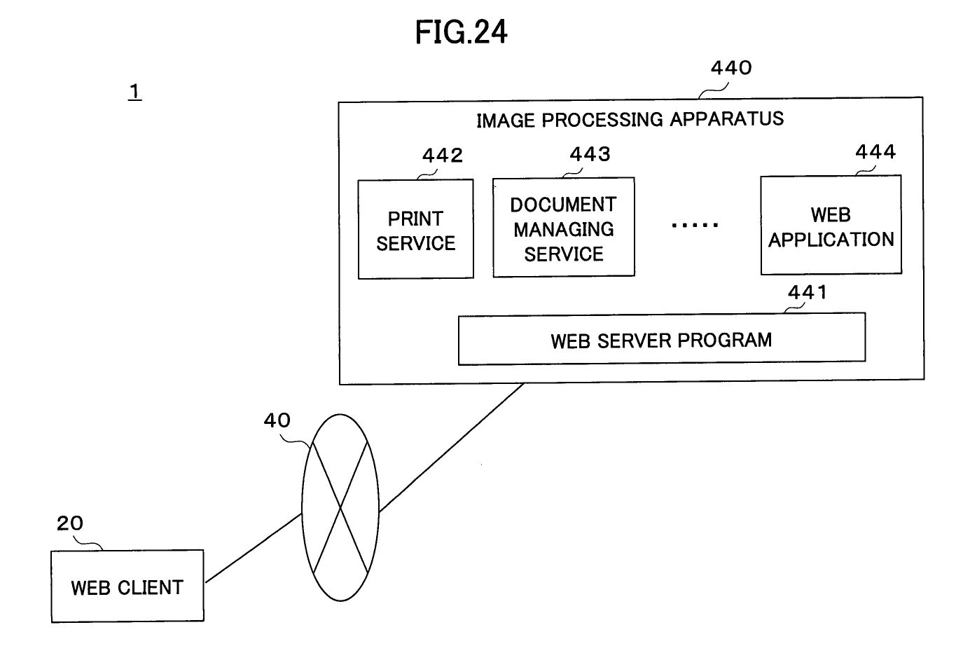

FIG. 24 shows yet another modification of the Web system 1, in which a single image processing apparatus 440 functioning as both the Web server and the respective SOAP servers is used. The same elements as those shown in FIG. 1 are denoted by the same numerical references, and explanation for them is omitted.

The image processing apparatus 440 is installed with Web server program 441, print service 442, document management service 443, and Web application 444. The Web server program 441 is the same program as Web server program 101 installed in Web server 10. Print service 442 and document management service 443 are the same services offered as Web services by the printer server 30a and the document managing server 30b, respectively. Web application 444 has functions corresponding to various page modules in Web server 10. In this manner, the functions of Web server 10, printer server 30a, and document managing server 30b may be realized by means of a single image processing apparatus 440.

Although the present invention has been described above based on the preferred embodiment, the present invention is not limited to the specific examples. There are many modifications and substitutions apparent to those skilled in the art without departing from the scope of the present invention defined by the appended claims.

This patent application is based on and claims the benefit of the earlier filing dates of Japanese Patent Application Nos. 2002-311708 filed Oct. 25, 2002, and 2003-356393 filed Oct. 16, 2003, the entire contents of which are hereby incorporated by reference.

1. A display data creating apparatus that creates display data representing a plurality of display sections, each of the display sections containing a prescribed type of information, in response to a request from a client apparatus supplied via a network, and transmits the display data to the client apparatus via the network, the display data creating apparatus comprising:
a determination part that determines for at least one of the display sections whether the information to be contained in a current display section satisfies a prescribed condition; and
a display data creating part that updates the current display section in accordance with the determination result to create the display data.

2. The display data creating apparatus of claim 1, further comprising:
a display configuration managing part that manages information about a determination function used in the determination carried out for the current display section, wherein the determination part determines whether the prescribed condition is satisfied in the current display section based on the determination function.

3. The display data creating apparatus of claim 1, wherein the prescribed condition varies for each of the display sections.

4. The display data creating apparatus of claim 1, wherein the determination part further determines whether the information to be contained in the current display section has been updated.

5. The display data creating apparatus of claim 1, wherein if the determination part determines that the prescribed condition is satisfied, then the display data creating part creates the display data so that the current display section is emphasized.

6. The display data creating apparatus of claim 5, wherein the display data creating part creates the display data so that the current display section is expanded when the prescribed condition is satisfied.

7. The display data creating apparatus of claim 5, wherein the display data creating part creates the display data so that the current display section is arranged so as not to be below the other display sections.

8. The display data creating apparatus of claim 1, wherein when the determination part determines that the prescribed condition is not satisfied for the current display section, then the display data creating part creates the display data so that the current display section is minimized.

9. The display data creating apparatus of claim 2, wherein the display configuration managing part further manages display configuration data defining the configuration of each of the display sections, wherein the display data creating part updates the current display section based on the display configuration data managed by the display configuration managing part.

10. The display data creating apparatus of claim 9, wherein the display configuration data of each of said at least one of the display sections includes the information about the determination function.

11 The display data creating apparatus of claim 9, wherein the display configuration data includes information indicating whether or not the prescribed condition is set for each of the display sections, and the display configuration data defining the display section for which the prescribed condition is set includes the information about the determination function.

12. The display data creating apparatus of claim 9, wherein the display configuration data includes an information acquiring function required to obtain necessary information for each of the display sections, wherein the display data creating part acquires the information to be contained in the current display section based on the corresponding information acquiring function.

13. The display data creating apparatus of claim 1, wherein:
the information to be contained in the current display section is information representing the condition of equipment connected on the network;
the determination part determines whether malfunction has occurred in the equipment; and
the display data creating part updates the current display section so as to indicate the occurrence of malfunction if it is determined that malfunction has occurred in the equipment.

14. The display data creating apparatus of claim 1, wherein:
the information to be contained in the current display section is information stored in a database connected on the network;
the determination part determines whether the database has been updated; and
the display data creating part updates the current display section so as to present the information stored in the database if it is determined that the database has been updated.

15. A display data transmission system comprising:
a client apparatus; and
a display data creating apparatus configured to create display data comprised of a plurality of display sections, each display section containing a prescribed type of information, in response to a request supplied from the client apparatus via a network, and to transmit the display data to the client apparatus, the display data creating apparatus comprising:
a determination part that determines for at least one of the display sections whether the information to be contained in a current display section satisfies a prescribed condition; and
a display data creating part that updatas the layout of the current display section in accordance with the determination result to create the display data.

16. A method for transmitting display data comprised of a plurality of display sections, each display section containing a prescribed type of information, to a client apparatus, comprising the steps of:
upon receiving a request from the client apparatus, determining for at least one of the display sections whether information to be contained in a current display section satisfies a prescribed condition;
creating the display data by updating the current display section in accordance with the determination result; and
transmitting the created display data to the client apparatus via a network.

17. The method of claim 16, further comprising the step of:
setting in advance the prescribed condition for each of said at least one of the display sections, the condition being different for each of the display sections.

18. The method of claim 16, wherein the determination step includes determining whether the information to be contained in the current display section has been updated.

19. The method of claim 16, wherein if the prescribed condition is satisfied in the determination step, then, the display data are created so as to emphasize the current display section.

20. The method of claim 19, wherein the display data are created so as to expand the current display section if the prescribed condition is satisfied in the current display section.

21. The method of claim 19, wherein the display data are created so that the current display section is arranged so as not to be below the other display sections if the prescribed condition is satisfied in the current display section.

22. The method of claim 16, wherein if it is determined that the prescribed condition is not satisfied in the determination step, then, the display data are created so as to minimize the current display section.

23. The method of claim 16, wherein:
the information to be contained in the current display section is malfunction information indicates whether malfunction has occurred in equipment connected on the network;
the determination step includes determining whether the malfunction information indicating that malfunction has occurred in the equipment; and
the display data are created so as to indicate the occurrence of malfunction if it is determined that malfunction has occurred in the equipment in the determination step.

24. The method of claim 16, wherein:
the information to be contained in the current display section is database information representing information stored in a database connected on the network;
the determination step includes determining whether the database information indicates that the database has been updated; and
the display data are created so as to present the information stored in the database if it is determined that the database has been updated in the determination step.

25. A machine readable program executed by a display data creating apparatus that creates display data comprised of a plurality of display sections, each display section containing a prescribed type of information, in response to a request from a client apparatus, the program comprising instructions of;
upon the request, causing the display data creating apparatus to determine for at least one of the display sections whether information to be displayed in a current display section satisfies a prescribed condition;
causing the display data creating apparatus to update the current display section in accordance with the determination result to create the display data; and
causing the display data creating apparatus to transmit the created display data to the client apparatus via the network.

26. A recording medium storing a machine readable program executed by a display data creating apparatus that creates display data comprised of a plurality of display sections, each display section containing a prescribed type of information, in response to a request from a client apparatus, the program comprising instructions of;
upon the request, causing the display data creating apparatus to determine for at least one of the display sections whether information to be displayed in a current display section satisfies a prescribed condition;
causing the display data creating apparatus to update the current display section in accordance with the determination result to create the display data; and
causing the display data creating apparatus to transmit the created display data to the client apparatus via the network.
